(19) United States
(12) Patent Application Publication
(10) Pub. No.: US 2012/0182943 A1
(43) Pub. Date: Jul. 19, 2012

(54) Method for Establishing a Bidirectional Communication Path in a Wireless Network

(75) Inventors: Michael Bahr, Muenchen (DE); Torsten Meyer, Kiel (DE); Norbert Vicari, Muenchen (DE)

(73) Assignee: SIEMENS AKTIENGESELLSCHAFT, Muenchen (DE)

(21) Appl. No.: 13/498,891

(22) PCT Filed: Aug. 6, 2010
(86) PCT No.: PCT/EP10/61480

§ 371 Date: Mar. 28, 2012

(30) Foreign Application Priority Data
Sep. 29, 2009 (DE) 10 2009 043 403.8

(51) Int. Cl. H04W 40/00

(52) U.S. Cl. 370/328

(57) ABSTRACT

A method for establishing a bidirectional communication path in a wireless network, where the network includes nodes comprising a sink node and a plurality of subscriber nodes, and where the communication path for the bidirectional transmission of data packets is to be established between the sink node and at least one queried node of the subscriber nodes. An uplink path from a particular subscriber node to the sink node is determined by periodically exchanging path messages between adjacent nodes of the network, where a particular path message signals the respectively shortest distance to the sink node, i.e., as a metric. A downlink path from the sink node to the at least one queried node is determined by inserting an address list into at least one of the path messages sent by the sink node, which list comprises the address of a respectively queried node.

### CROSS-REFERENCE TO RELATED APPLICATIONS

This is a U.S. national stage of application No. PCT/EP2010/061480 filed 6 Aug. 2010. Priority is claimed on German Application No. 10 2009 043 403.8 filed 29 Sep. 2009, the content of which is incorporated herein by reference in its entirety.

### BACKGROUND OF THE INVENTION

1. Field of the Invention

The invention relates to a method for establishing a bidirectional communication path in a wireless network i.e., in a wireless sensor network, where the network includes nodes comprising a sink node and a plurality of subscriber nodes, and where the communication path for the bidirectional transmission of data packets is to be established between the sink node and at least one queried node of the subscriber nodes. The invention also relates to a computer program product and a network, i.e., a wireless sensor network.

2. Description of the Related Art

Wireless networks are frequently implemented in the form of wireless sensor networks. A wireless sensor network is formed by a group of sensors, the node or sensor node of the sensor network, with a wireless interface. The respective sensors transmit, for example, measurement values and status information (generally: data) to at least one sink node, which typically functions as a gateway. If the sensors are not in direct range of the sink node, they also forward the data for others of the sensors. A multi-hop data transmission is thus established. For this purpose, the information about the next node in each case for forwarding to the sink node, i.e., over the path, is held in the sensor nodes. This information is referred to in general as a routing table entry.

The sensor nodes and also the sink node are typically designed for implementation with regard to extreme energy efficiency and also cost-effectiveness. This means that the nodes have only very limited resources at their disposal, in particular a low processing capacity and a small memory. The latter also means that the routing tables can only contain a small number of entries. Furthermore, only low data rates can be achieved over the wireless interface, whereby the resource must moreover be employed as economically as possible because the wireless interface has a particularly high energy consumption relative to the other components, such as a sensor or CPU.

Paths from a respective sensor to the sink node (gateway), i.e., in the uplink direction, can be established simply and in a resource-efficient manner by using collection tree protocols. Such protocols are based on the periodic exchange of packets between adjacent nodes which signal the respectively shortest distance to the sink in the form of a metric. These packets are referred to as beacons. Each node administers a path to the sink node by saving the adjacent node having the least distance to the sink for forwarding its data packets. However, messages such as configuration packets are occasionally also to be sent from the sink node to a selected node. For this purpose, corresponding paths must be established in the opposite direction, i.e., the downlink direction, which facility is not supported by the class of collection tree protocols. Additional mechanisms are therefore required when using this protocol.

An additional problem exists in that, in a large sensor network, the establishment of the paths must occur particularly efficiently, in particular because the available memory is not sufficient to hold paths for all nodes in the sink or in the nodes in the proximity of the sink. This means that the paths from the sink node to the selected node need to be detected and repeatedly established because they cannot be held permanently.

In the context of wireless sensor networks, two specifications are known which deal with the communication behavior in multi-hop networks: ZigBee and WirelessHART.

In addition to the cluster tree protocol, ZigBee supports a reactive multi-hop protocol based on Ad-Hoc On-Demand Distance Vector (AODV) routing. The cluster tree protocol allocates addresses depending on the topology, which solves the aforementioned problem efficiently but in practice results in considerable restrictions on the usability because the entire application logic likewise needs to be modified in the event of changes in the topology and address changes caused thereby. Since this is not practicable, the cluster tree method is not used by ZigBee in conventional applications.

In the more recent ZigBee Pro feature set, the cluster tree protocol is therefore not supported and the AODV based protocol is supplemented by many-to-one and source routing. A communication from the sink node to individual nodes can be implemented both by specifically establishing routes by the reactive AODV mechanism and also by way of the source routing option. The reactive establishment of routes results in a network-wide broadcast. As a result of the low memory capacity of the nodes in respect of the routing tables, this process must be repeated frequently, which leads to an increased consumption of resources, in particular of energy.

Source routing requires the recording of all intermediate nodes in data packets the are transmitted from a node to the sink node. This list of intermediate nodes is then included in the data packet that is transmitted from the sink node to one of the nodes (sensors). Disadvantages of this method are the reduction in the maximum size of the useful data in the packets (max. 128 bytes including the packet header in the Institute of Electrical and Electronic Engineers (IEEE) 802.15.4 standard) depending on the distance (counted in hops, i.e., the number of intermediate nodes) between node and sink node, and the additional complexity involved in implementing a second class of routing protocols.

WirelessHART supports both table-based and source routing. With WirelessHART, the routing is controlled centrally by a network manager that knows the topology. On account of the complex configuration process, table-based routing is more suitable for longer-term communication relationships. The resource limitation of the memory frequent reconfigurations of the routing tables inevitable because not all the communication relationships between the sink node and all the nodes of the sensor network can be held in the memory. Source routing solves the memory problem, but is restricted to a total of four hops with WirelessHART. Likewise, the complexity involved in implementing two routing protocols should not be ignored.

In the world of wireless data communication, i.e., IEEE 802.11 WLAN, protocols are likewise known that establish paths to sink nodes. The current draft standard IEEE 802.11s D2.02 also contains the hybrid mesh routing protocol (HWMP) (published in IEEE 802.11s/D2.02 Part 11: Wireless LAN Medium Access Control (MAC) and Physical Layer (PHY) Specifications Amendment 10: Mesh Networking, Chapter 11 B.9). In addition to on-demand mode, it is also possible to establish a route tree, which may also be bidirectional, from a particular node, i.e., the root MP. As a rule, a root MP is a sink node or gateway. Two different methods are specified for this purpose: proactive PREQ mode and RANN mode.

In the proactive PREQ mode a path request message (PREQ) is sent periodically with a broadcast address as a sought destination by the root MP into the network. As a result, a unidirectional path to the root MP is established in each node of the network. The result of this method corresponds to the collection tree routing in the sensor networks considered. However, as a rule the PREQ message is “flooded”, i.e., it is immediately forwarded by broadcast with an updated path metric by the node that has received the message to all the adjacent nodes.

The bidirectional paths in the root MP to the individual nodes can be generated in proactive PREQ mode by HWMP using two different methods. When a “proactive PREP” flag is set, each node which has received the PREQ message to the broadcast address responds with a corresponding path reply message (PREP). This method is not particularly efficient even in WLAN networks, and thus also not in resource-limited wireless networks. That is, N*L transmissions of PREP packets per PREQ message sent out by the root MP would be necessary, where N represents the number of nodes in the tree and L represents the average tree depth. The method is not energy efficient and produces overhead. In addition, the root MP would have a path to all nodes in the network, which would lead to resource problems on account of the size of the routing table. If the “proactive PREP” flag is not set, then the node only sends a PREP message when it requires a bidirectional path, i.e., a path from the root MP to the node. The initiator here is the node, whereby the sending of PREP messages is maintained as long as the node sends data to the root MP. With this method, the routing table in the root MP is smaller but in the sensor network it would encompass all the sensor nodes and therefore be too large for a resource-limited wireless network because each node sends data to the sink node. A further problem with this method is the fact that the requirement for a bidirectional path is known only at the sink node/root MP but the bidirectional path is initiated only from the node in the tree and there is no possibility in HWMP to convey this requirement to the node tree.

The Route Announcement (RANN) mode of HWMP differs merely in the establishment of the bidirectional routes. In this situation, the root announcement message (RANN message) corresponding to the proactive PREQ message described above is flooded in the network. However, no entry is made in the routing table but only the best predecessor node to the root MP is determined. The information is not used for forwarding data packets but merely for forwarding routing messages, i.e., path request (PREQ) messages. The creation of the paths between the nodes in the tree and the root MP occurs by way of a PREQ/PREP message exchange by unicast. This exchange of routing messages is likewise initiated by the node in the tree. It is likewise not possible to communicate the requirement present at the sink node/root MP for a bidirectional path to the node in the tree. In addition, a PREQ/PREP message exchange would need to occur for each node to achieve the functionality of a collection tree protocol.

In HWMP, when a data packet is sent on the path, the useful life of the corresponding outward path and also of the associated return path is again set to the maximum value. In the sensor networks described above, this would result in a bidirectional path, once established, always remaining bidirectional because data packets are sent time and time again from the sensors to the sink nodes and the useful life of the corresponding path from the sink node to the sensor node would thereby always be renewed at the same time. The bidirectional path would thus never be deleted by any expiry of the useful life, so-called timeout.

HWMP permits multiple destination addresses in the PREQ messages. By definition, in reactive mode either one or multiple destination addresses for individual nodes or only the broadcast address for the tree may be contained in the PREQ in this situation. Energy-intensive query messages are thereby reduced.

### SUMMARY OF THE INVENTION

It is therefore an object of the present invention to provide a method with which a bidirectional communication path can be established in a wireless network, i.e., a wireless sensor network. In accordance with the invention, the method is performed efficiently with a low resource requirement in a wireless network. It is also an object of the present invention to provide a computer program product and a network in which a bidirectional data transmission is possible with a low resource usage.

These and other objects and advantages are achieved in accordance with the invention by a computer program product a network, and a method for establishing a bidirectional communication path in a wireless network, i.e., in a wireless sensor network, where the network includes nodes comprising a sink node and a plurality of subscriber nodes, and where the communication path for the bidirectional transmission of data packets is to be established between the sink node and at least one queried node of the subscriber nodes. In accordance with the method of the invention, an uplink path from a particular subscriber node to the sink node is determined in that a periodic exchange of path messages, i.e., messages containing path information, occurs between adjacent nodes of the network, where a particular path message signals the respectively shortest distance to the sink node, i.e., a metric, and each of the nodes administers a path to the sink node by saving the address of the adjacent node having the best metric to the sink node for forwarding the data packets.

The path messages can constitute beacons, such as those known from collection tree protocols. With this procedure for determining the uplink path, the respectively shortest paths between the sink nodes and a particular subscriber node are determined. This procedure is known overall as collection tree protocol, as described above. The exchanged messages are referred to as beacons. The best metric comprises, for example, the smallest number of subscriber nodes lying on the path.

In accordance with the method of the invention, a downlink path from the sink node to the at least one queried node is determined in that an address list is inserted into at least one of the path messages sent from the sink node, which list comprises the address of a respectively queried node. Each subscriber node that receives a path message having an address list inserts the address list in the path message it sends out. Here, the subscriber node or nodes addressed in the address list change as queried nodes to a dedicated transmission state upon receiving the path message with the address list.

The method in accordance with the invention thus inserts the address or addresses of the queried node or nodes into a beacon in accordance with the collection tree protocol. By appending an address list of the queried nodes to the path message (beacon), it is possible for the queried nodes to register explicitly with the sink node without the sink node having to flood the wireless network energy-intensively with an additional query message. This takes into consideration the limited energy resources in a wireless network, i.e., a wireless sensor network.

As a result of the restriction to a few queried sink nodes, this additionally produces the positive or advantageous effect that the routing table of the sink node contains only those subscriber nodes with which the sink node actually communicates. This takes into consideration the very limited memory capacity of the sink node and of the subscriber nodes that are intermediate nodes.

Through advantageous configuration of maximum useful life, path message interval (beacon interval) and combination of the lists of queried sensor nodes, the invention can find application in many forms of wireless networks.

In an embodiment, upon receiving a path message with the address list a queried node removes its address from the address list before the queried node sends out its path message with the address list to the nodes adjacent thereto.

In a further embodiment, a subscriber node takes account of path messages only from an adjacent node such as is selected based on the path message as the next hop to the sink node. As a result, the resources available in the nodes are used economically.

In another embodiment of the invention, a further method is provided for establishing a bidirectional communication path in a wireless network, i.e., in a wireless sensor network, where the network includes nodes comprising a sink node and a plurality of subscriber nodes, and where the communication path for the bidirectional transmission of data packets is to be established between the sink node and at least one queried node of the subscriber nodes. In accordance with the contemplated embodiments of the method of the invention, an uplink path from a particular subscriber node to the sink node is determined in that a periodic exchange of path messages occurs between adjacent nodes of the network, where a particular path message signals the respectively shortest distance to the sink node, i.e., a metric, and each of the nodes administers its path to the sink node by saving the address of the adjacent node having the best metric to the sink node for forwarding the data packets. A downlink path from the sink node to the at least one queried node is determined in accordance with the presently contemplated embodiment of the invention in that, in addition to the path messages sent periodically, a query message having an address list that includes the address of a particular queried node is sent out by the sink node, the query message is forwarded by each node receiving this query message to the respectively adjacent node, and the subscriber node or nodes addressed in the address list change as queried nodes to a dedicated transmission state upon receiving the query message with the address list.

The query message automatically updates the communication path to the sink node in all nodes which receive this query message. Similar to the on-demand mode of HWMP, this procedural principle is based on sending an explicit query message having a plurality of destination addresses. Such an explicit query message merely needs to be distributed once in the wireless network, which means that the number of additional routing packets can be kept low. Energy-efficient operation of the wireless network is thereby enabled. A further advantage consists in the fact that a combination of a query message with path establishment to the sink node is accompanied by an additional update of the paths to the sink node. A query message which has been initiated from the sink node automatically updates the path to the sink node in all nodes which receive this query message.

In another embodiment, the subscriber nodes which are addressed in the address list remove their address from the address list prior to forwarding to the respectively adjacent nodes.

Since nodes receiving a query message, the address of which nodes is contained in the list of destination addresses, delete their address from the list prior to forwarding, it can happen that the list of destination addresses is empty but not yet all subscribers have received the query message for updating the paths to the sink node. Although no abnormal behavior of the network results if the subscriber nodes do not receive the query message, the up-to-dateness of the paths to the sink node can certainly be increased by a forwarding operation. To this end, the subscriber node must be advised to also forward a query containing an empty list of destination addresses. The following options exist for this purpose:

In a first embodiment, the subscriber nodes that receive a query message initiated from the sink node forward this to their adjacent nodes. This occurs preferably independently of whether or not destination addresses are present in the address list.

In accordance with another embodiment, the subscriber nodes that receive a query message initiated from the sink node with a broadcast address contained therein as the destination address of the query message forward the query message even with an empty destination address list to all subscriber nodes and do not interpret the broadcast address as a query. However, subscriber nodes having the contained destination addresses are invited to mark their data packets to the sink node. As a result, the broadcast address then requires special handling because not every subscriber node but only certain subscriber nodes should mark the data packets.

In a further embodiment, an indicator is inserted into the query message that signals to the nodes receiving the query message that the query message is to be forwarded to the adjacent nodes even when the address list is empty. If the indicator is set, the query message is forwarded even if the destination address list is empty. If the indicator is not set, the query message is not forwarded if the destination address list is empty.

In a further embodiment, the queried node provides at least the next data packet to be sent to the sink node in a predetermined manner with a marker that is interpreted by the subscriber nodes lying on the communication path to the sink node as an indicator for a forwarding message.

As a result of integrating the functionality of response messages into normal data packets, a further saving of routing packets is achieved. The establishment of communication paths thereby becomes possible in the wireless network without generating additional signaling traffic. This means that virtually no additional energy is required. The addition of several bytes to existing data packets requires substantially less energy than the sending of additional packets. A further advantage of the disclosed embodiments of the method of the invention consists in the fact that as a result of the establishment of local routing tables the method scales in comparison with the source routing methods known from the prior art.

In accordance with a further embodiment, the subscriber nodes that lie on the path from a queried node to the sink node, and also the sink node, enter the downlink path in their forwarding table if they receive a marked data packet from one of the queried nodes.

Expediently, at least the following items of information are entered in the forwarding table:
a destination address, which is the address of the queried node, and corresponds to the source address of a marked data packet;
an address of an adjacent subscriber node (next hop), which is the address of the next subscriber node on the path to the destination address. This corresponds to the sender address of the marked data packet; and
an item of information corresponding to a useful life of a communication path, where this specifies a period of time after which the path to the queried node is deleted from the forwarding table.

Provision is furthermore made that the useful life of a path is reset to its maximum value upon the occurrence of one of the following events:
upon receipt or forwarding of a data packet provided with a marker from the queried node, which is being transmitted to the sink node, or
upon receipt or forwarding of a data packet sent from the sink node, which data packet is addressed to the queried node.

In particular, the subscriber nodes are notified of the useful life of the communication path for a configuration. It is also possible to insert this value into the marked data packets, which then means that this value is used for the routing table.

The maximum value for the useful life of the path from the sink node to the queried node should be chosen such that this path still exists when the next data packet is sent by the sink node on this path.

It is possible to dispense with a path metric for the paths from the sink node to the queried sensor nodes because the path from the sink node to the queried sensor node corresponds exactly to the already existing path from the queried sensor node to the sink node.

In a further embodiment, a marked data packet is provided with a sequence number. If a marked data packet contains a sequence number that enables the sequence of the (marked) data packets from one and the same queried sensor node to be unambiguously determined, then it is expedient to incorporate the sequence number into the routing table entry because correct chronological processing is simplified in the event of data transmission problems.

The association of a subscriber node with its predecessor in the tree structure can switch to a different predecessor node due to changing environmental conditions, as a result of which the metric to the sink node changes. In the worst case, a break occurs in a communication link between two adjacent subscriber nodes which means that it is no longer possible to transmit data packets between the subscriber node and its predecessor node. Constellations are possible in the topology in which the sink node is not aware of the interruption of the path to the subscriber node and the packets cannot therefore be transmitted from the sink node to the subscriber node. For this reason, all the outbound paths from the sink node which went via this link that is no longer used or even no longer available must be updated in all intermediate nodes and in the sink node. This operation is referred to in the following as path maintenance.

The uplink paths are updated automatically, for example, by way of the received path messages (beacons). In order to also update the paths in the downlink direction, the data packets of the queried nodes must be marked for as long as the corresponding downlink path is to exist.

The need to perform path maintenance on a downlink path in the queried node in question is expediently identified by a marker flag, where when the marker flag is set the data packets to the sink node are identified by the marker.

For this purpose, two embodiments are available.

In order that a queried node knows whether a downlink path which must be maintained exists to it from the sink node, in accordance with an advantageous embodiment of the method the useful life of a downlink path is saved in the queried nodes in question. Expediently, a timer initialized with the maximum path useful life is started when a downlink path is created. The creation of the path is the point in time at which the first marked data packet is dispatched following a query from the queried node. In particular, in this subscriber node the initial useful life for the downlink path from the sink node to this subscriber node corresponds to the useful life that is set for this downlink path in the intermediate nodes.

In accordance with the contemplated embodiment the marker flag and a further flag identifying a first data packet are set by a subscriber node as soon as the latter becomes a queried node, where the further flag is deleted on transmission to the sink node of the first data packet identified by a marker. In particular, the at least one queried node no longer provides a data packet to be sent to the sink node with the marker if the timer has expired and the further flag and the marker flag are not set. Alternatively, the further flag is combined with a non-negative marker resource which takes account of the number of the at least marked data packets following each query by the sink node.

In accordance with a further embodiment, a marker flag is used for the existence of a downlink path, where the queried node in question provides the data packets sent from it to the sink node with the marker, as long as the marker flag is set. The marker flag is set by a path message in which the subscriber node is contained in the address list (i.e., is queried) and/or data packets that the queried node receives from the sink node.

As a result of the combination of these two conditions, a subscriber node needs to be queried only once in the path messages for the duration of a downlink path, regardless of how many path message intervals this path spans. This means that it is also possible, in spite of the limited number of queried subscriber nodes in the path message regardless of the maximum permissible size of the path message, for any number of downlink paths to exist simultaneously as long as the sink node is transmitting data packets on these downlink paths. This also means that it is possible to choose the path message interval and the useful life of the downlink path completely independently of one another.

The setting of the marker flag by data packets received by the queried node from the sink node can in principle also be dispensed with. However, only a limited number of downlink paths can then exist simultaneously because the queried nodes must be queried time and time again with each path message and the space for the addresses of the subscriber nodes in the path messages is limited. It is moreover necessary to consider that the useful life of the downlink path is greater than the path message interval if a continuous presence of the downlink path is desired.

In accordance with a further embodiment, the marker flag is reset when a predetermined number of data packets provided with a marker have been sent to the sink node from a particular queried node (SO).

In an alternative embodiment, the marker flag is reset when the queried node is no longer contained in the address list in a predetermined number of received path messages.

The invention also comprises a computer program product which can be loaded directly into the internal memory of a digital computer and comprises software code sections with which the steps of the method according to the invention are performed when the product runs on the computer.

The invention furthermore creates a network, i.e., a wireless sensor network, where the network includes nodes comprising a sink node and a plurality of subscriber nodes, where the communication path for the bidirectional transmission of data packets can be established between the sink node and at least one queried node of the subscriber nodes. With regard to the network in accordance with the invention, an uplink path from a particular subscriber node to the sink node can be determined in that a periodic exchange of path messages occurs between adjacent nodes of the network, where a particular path message signals the respectively shortest distance to the sink node, i.e., a metric, and each of the nodes administers its path to the sink node by saving the address of the adjacent node having the best metric to the sink node for forwarding the data packets. A downlink path from the sink node to the at least one queried node can be determined in that an address list is inserted into at least one of the path messages sent from the sink node, which list comprises the address of a respectively queried node; each subscriber node that receives a path message having an address list appends the address list to the path message it sends out; and the subscriber node or nodes addressed in the address list change to a dedicated transmission state upon receiving the path message with the address list of the queried node.

The network in accordance with the invention exhibits the same advantages as have been described in conjunction with the disclosed embodiment of the method in accordance with the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be described in detail in the following with reference to exemplary embodiments in the drawing. In the drawings:

FIG. 1 shows a schematic, exemplary sensor network having a plurality of nodes and a particular path of a subscriber node to a sink node;

FIGS. 2A, 2B show two possible implementations of path messages with queries to the sensor nodes of the sensor network of FIG. 1;

FIG. 3 shows an operational sequence in accordance with the invention for communication in aqueried node J in accordance with an embodiment of a method for path maintenance;

FIG. 4 shows an operational sequence in accordance with the invention for communication in the queried node J in accordance with an alternative embodiment of a method for path maintenance; and

FIG. 5 is a flow chart of the method in accordance with an embodiment of the invention; and

### DETAILED DESCRIPTION OF THE PREFERRED EMBODIMENTS

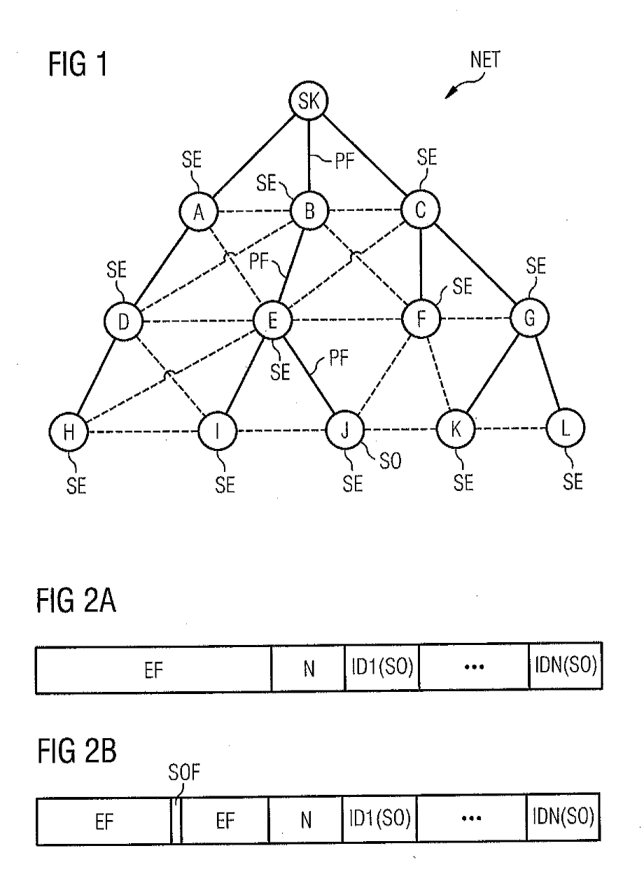

FIG. 1 shows an exemplary sensor network NET which includes nodes comprising a sink node SK and a plurality of subscriber nodes SE. The subscriber nodes constitute, for example, sensor nodes and have a unique address that is identified in FIG. 1 by A, B, C, . . . , K, L. Communication connections (i.e., links) existing between particular subscriber nodes SE are represented in FIG. 1 by a thin dashed line. Lines shown in bold between two nodes represent a communication path between the connected nodes. The paths between the individual subscriber nodes SE have been established in accordance with the collection tree protocol described above. A communication path, discussed in detail subsequently, between the sink node SK and the subscriber node SE having the address “J” (i.e., node J) is identified by PF. Subscriber nodes B and E lying on this communication path are referred to as intermediate nodes.

The paths of the subscriber nodes SE to the sink node SK are established such that each of the subscriber nodes A to L notifies its shortest distance to the sink node SK in path messages referred to as beacons. The sink node SK makes itself known to itself in its environment with beacons having the distance “0” or another initial start value that is the smallest value. After adding the distance to the subscriber node from which another subscriber node has received a beacon to the distance to the sink node notified in the beacon, the subscriber node knows the corresponding distances to the sink node via its adjacent subscriber nodes. A subscriber node SE sends data that is intended for the sink node SK to the adjacent subscriber node SE via which it has the shortest distance to the sink node SK. After a finite time, the information about the distance to the sink node SK, starting from the sink node SK, has reached all the subscriber nodes SE in the network.

In the description which follows it is assumed that the sink node SK would like to send three data and control packets to the subscriber node having the address “J”. For this purpose, a communication path from the sink node SK to the specific subscriber node must first be determined, where this subscriber node is referred to as queried node SO.

To this end, a list of addresses of the subscriber nodes to which the sink node SK would like to send data is appended to the beacon sent out from the sink node SK to establish particular paths to the sink node SK. In the present case, this is the subscriber node SE having the address “J”. Each subscriber node which receives such a beacon includes this address list in its next beacon. Consequently, the addresses are notified to all subscriber nodes SE of the sensor network NET. If a subscriber node SE that is contained in this address list (here: node “J”) receives such a beacon, then the subscriber node SE removes its address from the address list before it forwards the list to its adjacent subscriber nodes SE in its next beacon.

In principle, it is sufficient to consider only those beacons that are received from an adjacent subscriber node SE which is then selected based on this beacon as the next node (hop) to the sink node SK.

In the exemplary embodiment depicted in FIG. 1, the sink node SK therefore enters the address of the subscriber node SE having the address “J” as a queried node in its beacon. After a finite time, this query in the beacon of one of its adjacent subscriber nodes (here, the nodes I, E, F or K) reaches the node J. In the exemplary embodiment, in this situation only those beacons are taken into consideration that are received from an adjacent subscriber node SE, which is then selected, also repeatedly, based on this beacon as the next hop to the sink node SK. In the exemplary embodiment, these are the beacons of node E.

In FIG. 2A, a possible implementation of a beacon having a query to a particular subscriber node SE of the sensor network NET is represented. EF here in a conventional beacon identifies fields already present. N identifies the number of queried subscriber nodes SE. ID1(SO), . . . , IDN(SO) serve to designate the identifiers (addresses) of the queried subscriber nodes. The address list can, in principle and as illustrated in FIG. 2A, comprise a number N of queried nodes, where the number N is ≧0. Field N can also be omitted if the number and position of the queried subscriber nodes are unambiguously given by the structure of the beacon. This is the case if the addresses of the queried subscriber nodes SE immediately follow EF as the last data field.

FIG. 2B shows a preferred embodiment, according to which the beacon additionally comprises a query flag SOF that serves to signal to the subscriber nodes SE receiving the beacon that subscriber nodes for a bidirectional communication link between the sink node and the subscriber nodes are being queried and these queried subscriber nodes are contained in the inserted address list. Only in the situation when the query flag SOF is set are the additional fields (number N of queried nodes and also the identifiers (addresses) of the queried nodes) appended to the beacon. Here too the field N could be omitted if the end of the address list can also be recognized unambiguously without the field N (for example, by the end of the message).

After a beacon has been received by the queried node that is contained in the address list of the beacon, the queried node SO (here node J) marks its next data packet using a suitable mechanism, such as a flag, for processing in the routing algorithm. If a subscriber node SE has been queried, then it must provide at least the next data packet to the sink node SK with this marker. Since the points in time for sending data packets are however independent of the receipt of a beacon with a query, the marker set on the queried node (for example, in the form of a marker flag or a similar data structure) makes it possible to determine whether the data packets need to be marked in accordance with the invention. If the marker is set correspondingly, then all the data packets of the queried node SO will be marked. If the queried node SO is queried in a beacon, then the queried node SO sets the marker. The manner in which the marker can be reset will be described below.

The intermediate nodes on the path to the sink node SK (here the nodes E and E) and also the sink node SK itself handle a marked data packet similarly to a response message and enter the corresponding route to the queried node SO (node J) in their routing table. At least the following information items must be entered in the entry in the routing table:
Destination address: This is the address of the queried node SO (here: node J), i.e., the source address of the marked data packet.
Next hop to the destination node: The address of the next sensor node on the on the way to the queried sensor node, i.e., the sender address of the marked data packet.
A useful life of the path: The period of time after which the path to the queried node SO is deleted from the routing table.

Different mechanisms, which are described below, reset the useful life to its maximum value. This happens in any case upon receipt of a data packet marked in accordance with the invention from the queried sensor node SO (destination address) and upon receipt of data packets from the sink node SK that are addressed to the queried sensor node SO. The maximum value for the useful life can be notified to the intermediate node through configuration. It is also possible to insert this value into the marked data packets, which means that this value is taken for the routing table.

The maximum value for the useful life of the path from the sink node SK to the queried node SO (i.e., the downlink path) should be chosen such that the path still exists when the next data packet is sent by the sink node SK on this path. A path metric is not required because the path from the sink node SK to the queried node SO corresponds exactly to the already existing path from the queried sensor node to the sink node.

Alternatively, similarly to the on-demand mode of HWMP, an explicit query message having a plurality of destination addresses can be sent. While this requires additional routing packets, together with the other mechanisms of the method, such an explicit query message does however only need to be distributed once in the sensor network, which means that the number of additional routing packets is low. Not all the nodes of the sensor network need to receive the query message. In meshed networks, the query message is, however, mostly forwarded to all nodes. A combination of a query message with path establishment to the sink node SK therefore brings about an additional updating of the paths to the sink node SK. A query message which has been initiated from the sink node SK automatically updates the path to the sink node in all subscriber nodes that contain this query message.

Since nodes which receive such a query message and whose address is contained in the list of destination address delete their address from the list before forwarding, it can happen that the list of destination addresses is empty but not all the subscriber nodes SE have yet received the query message for updating the paths to the sink node SK. No abnormal behavior of the network NET results however if these subscriber nodes SE do not receive the query message.

However, the up-to-dateness of the paths to the sink node SK can be increased by a forwarding operation. To this end, the subscriber nodes SE are advised to also forward a query containing an empty list of destination addresses. The following options exist for this purpose:
In general, all the query messages that have been initiated from the sink node SK are forwarded, regardless of whether or not a destination address is contained in the query message.
The broadcast address is specified as the destination address. However, since the sensor nodes with the contained sensor nodes are actually requested to send a response message to the sink node, the broadcast address requires special handling because not every sensor node but only certain sensor nodes are to send a response message.
A flag is used in the query message. If the flag is set, the query message is forwarded even if the destination address list is empty. If the flag is not set, the query message is not forwarded if the destination address list is empty.

The queried nodes SO react to the receipt of a query message in the same way as upon receiving a beacon, in which they are included in the list of destination addresses, in other words by the marking of their data packets to the sink node SK.

The useful life of the path PF is reset to the initial value with each data packet by the forwarding of data packets on this path. As a rule, a data packet renews the useful life of both directions of a path PF. For the method in accordance with the invention, it is necessary that data packets which are not marked in the manner described renew the useful life only for the direction of the path in which they are forwarded. This means that the path PF from the sink node SK to the queried node SO (downlink path) is updated by packets transmitted by the sink node SK to a subscriber node SO, but not by unmarked data packets that the subscriber node SO sends to the sink node SK in the context of its normal function. Otherwise this would result in a bidirectional path, once created, remaining permanently bidirectional.

An exception thereto is constituted by the data packets, marked in the manner described, of the queried node SO which are transmitted to the sink node SR. By means of the routing functionality notified by their marker, they also reset the useful life of the downlink path from the sink node SK to the queried node SO back to the initial value.

The method of the invention also provides for the maintenance of a bidirectional path, once established, between the sink node SK and a queried node SO in the event of changes to the topology.

The association of a subscriber node SE with its predecessor in the tree structure of the network can switch to a different predecessor node due to fluctuating environmental conditions, which causes the metric to the sink node to change. In the worst case, a break in the link occurs which means that it is no longer possible to transmit data packets between the subscriber node and its predecessor node. Constellations are possible in the network topology in which the sink node is not aware of the interruption of the path to the subscriber node and the data packets cannot therefore be transmitted from the sink node SK to a subscriber node SE situated on the path or to the queried node SO. For this reason, all the outbound paths from the sink node SK which went via this link that is no longer used or no longer available must be updated in all intermediate nodes and in the sink node SK.

The paths in the uplink direction, i.e., from a subscriber node SE or the queried node SO in the direction of the sink node SK, are updated automatically by way of the beacons received. In order that the downlink paths in the reverse direction from the sink node SK to the queried node SO are also updated, the data packets of the queried nodes SO must be marked in the manner described for as long as the corresponding path from the sink node SK to the queried node SO is to exist.

### Method A

In order that a queried node SO also knows whether a path which must be maintained exists to it from the sink node SK, the useful life of the downlink path from the sink node SK to the queried node SO (abbreviated to SK→SO) is also included in the queried node SO. For this purpose, a timer is provided which is initialized with the maximum useful life of the path and is started when the path from the sink node SK to the queried node SO (sensor node) is created. This is the point in time at which the first marked data packet is dispatched following such a query from the queried node SO. In particular, in this sensor node the initial useful life for the path from the sink node SK to the queried node SO corresponds to the useful life that is set for this path in the intermediate nodes.

The useful life for the downlink path SK→SO in the queried node SO is reset with each packet received from the sink node SK to the predetermined initial value, i.e., the maximum useful life. Data packets, i.e., also marked data packets, which the queried node SO sends as originator to the sink node SK do not as a rule modify the timer of the queried node SO. An exception is the first marked data packet after receipt of a beacon in which the node SO was queried. The marked data packet sets the timer to the start value and can be recognized by way of a further flag, i.e., the first data packet flag EDPF. If the first data packet flag EDPF is set, when a marked data packet is sent the timer is set to the initial value and the first data packet flag EDPF is deleted. The first data packet flag EDPF is set upon receipt of a beacon with a query for the queried node SO.

If the timer expires and the first data packet flag EDPF is not set at this point in time, the marker flag MF will be reset, which means that subsequent data packets from the queried node SO will no longer be marked.

The first data packet flag EDPF can also be combined with the marker flag MF in a non-negative integer marker resource MR. The following rules apply with regard to this alternative:

| | |
|---|---|
| Initialization | MR := 0 |
| Receive a beacon with | MR := MR + n |
| query SO | n ≧ 1 |
| Send a data packet | MR := 0 |
| when MR = 0 | Data packet unmarked |
| Send a data packet | MR := 1 |
| when MR = 1 and timer > 0 | Data packet is marked |
| | Timer unchanged |
| Send a data packet | MR := 1 |
| when MR = 1 and timer = 0 | Data packet is marked |
| | Timer is set to start value |
| Send a data packet | MR := MR − 1 |
| when MR > 1 | Data packet is marked |
| | Timer is set to start value |
| Timer expires | MR := MR − 1 |
| Receive a data packet | MR := 1 |
| from sink node SK when | Timer is set to start value |
| MR = 0 | |
| Receive a data packet | MR := MR |
| from sink node SK when | Timer is set to start value |
| MR > 0 | |

Here, summand n corresponds to the number of at least marked data packets after each beacon with a query. It is sufficient if n=1.

The above behavior with regard to resetting the useful life to the maximum value is somewhat different in the queried sensor node SO than in the intermediate nodes and the sink node SK.

This results in the fact that the timer in the queried sensor node SO is more likely to expire than the timers for the useful life of the downlink path SK→SO in the intermediate nodes and in the sink node SK. This does not result in any abnormal behavior because the decisive timer for the final transmission of data packets to the queried node is situated in the intermediate node which is the immediate predecessor of the queried sensor node SO. The faster timeout on the queried node SO is intentional because strictly speaking this timer corresponds to the time or the statement that the downlink path SK→SO is to be maintained, i.e., that the data packets from the queried node SO to the sink node SK are marked. If the timer on the queried node SO expires, then the useful life of the downlink path SK→SO will no longer be renewed by the no longer marked data packets and will be deleted in the intermediate nodes and in the sink node SK after expiry of the timer.

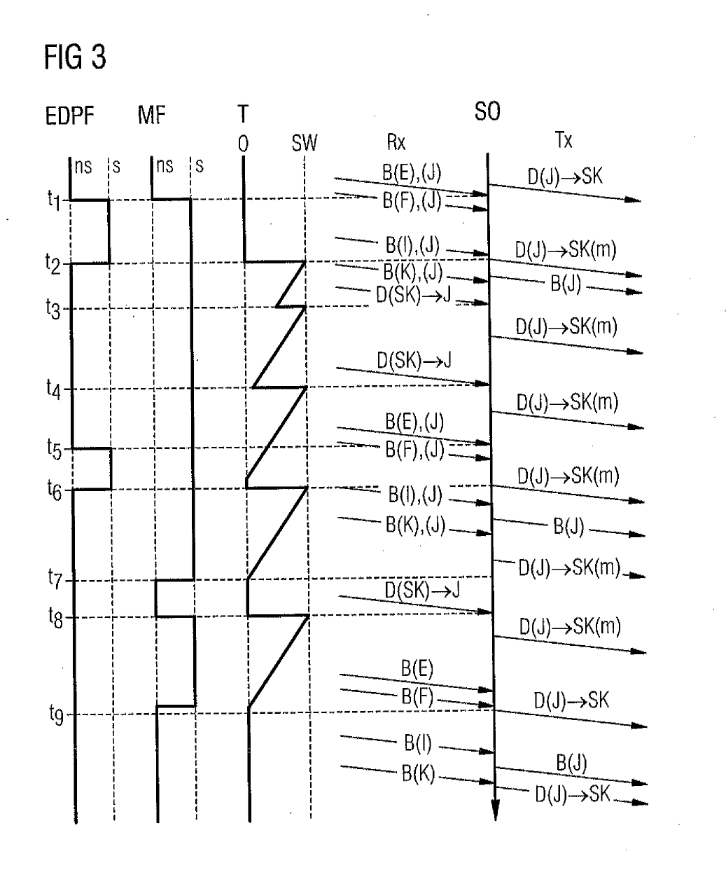

Should the queried node SO receive a data packet from the sink node SK within this period of time (i.e., the timer has expired in the queried node SO but the downlink path SK→SO still exists), it sets the marker flag MF anew, initializes its timer with the maximum value for the useful life and re-marks its data packets in accordance with the invention for as long as the timer is active. This is illustrated by way of example in FIG. 3.

FIG. 3 thereby shows the operational sequences in accordance with the invention in the queried node SO having the address “J” in accordance with the method A just described, where the marker flag MF and the first data packet flag EDPF are used. A flag not set is identified by “ns”, a set flag by “s”. To the right of these are shown the data packets received (Rx) or transmitted (Tx) by the queried node SO having the address J, where the data packets are to be read as follow: “B(E),(J)” means that a beacon of the subscriber node having the address E (originator of the beacon) is received, where the beacon contains a query for the node having the address J. “D(J)→SK” means that a data packet is transmitted/sent from the node having the address J to the sink node SK. A data packet that is destined for the sink node SK and marked is identified by D(J)→SK(m). The chronological sequence in the figure runs from top to bottom.

Initially, both the first data packet flag EDPF and the marker flag are not set. At the point in time tₗ, the queried node SO having the address J (i.e., node J) receives a beacon from the subscriber node E, in which node J is queried (B(E),(J)). As a result, both the first data packet flag EDPF and the marker flag MF are set (i.e., the flags each switch from “ns” to “s”). Between points in time t₁ and t₂, node J receives further beacons from the nodes F and I, in each of which the node J is queried. At point in time t₂, node J sends a marked data packet to the sink node SK (D(J)→SK(m)). As a result, the timer T is set to its start value SW. Also, the first data packet flag EDPF is changed to “not set-ns”. The marker flag MF remains set “s”. The timer T decrements with the passage of time. At point in time t₃, node J receives a data packet from the sink node SK (D(SK)→J), whereupon the timer T is reset to its start value SW. The same occurs at point in time t₄. At point in time t₅, node J receives a beacon from node E, in which node J is queried (B(E),(J)), whereupon the first data packet flag EDPF changes its status to “set-s”. Between t₅ and t₅ the timer T has dropped from its start value SW to the value 0. The marker flag MF remains set “s” because the first data packet flag EDPF is set “s”. The timer T remains at 0 up to the point in time t₆, at which it is set to its start value SW because node J transmits a marked data packet to the sink node SK (D(J)→SK(m)). At the same time, the first data packet flag EDPF has its status changed to “not set-ns”. At point in time t₇, the timer has dropped to its value 0, whereupon the marker flag MF also changes its status to “not set-ns” because the first data packet flag EDPF is likewise “not set-ns”. At point in time t₈ the node J receives a data packet from the sink node SK(D(SK)→J), whereupon the marker flag changes its status to “set-s” and the timer is set to its start value SW. Between t₈ and t₉ node J receives a beacon B(E) in which no node is queried. Therefore, the statuses of the first data packet flag EDPF and the marker flag MF are not changed. Also, the timer T reaches the value 0, and the marker flag MF is set to “not set-ns”. At point in time t₉, at which node J sends a data packet to the sink node SK, the timer T already has a value of 0, similarly in the meantime the marker flag is “not set-ns”. A data packet sent from node J to the sink node SK is therefore not marked (D(J)→SK).

### Method B

An alternative and, on the queried node SO, timerless method contains a corresponding flag MF(B.1) or MF(B.2) for the existence of the downlink path SK→SO. The queried node SO marks its data packets for as long as the marker flag MF is set. Here, B.1 and B.2 denote two different methods which are described in detail below. The marker flag MF is set by beacons in which the node is contained in the list of the destination address, i.e., queried, and/or by data packets which the queried node SO receives from the sink node SK.

As a result of the combination of these two conditions, a node only needs to be queried once in the beacons for the duration of a downlink path SK→SO, regardless of how many beacon intervals the existence of this path spans. This means that in spite of the restricted number of queried nodes SO in the beacon any number of downlink paths SK→SO can also exist simultaneously, regardless of the maximum permissible size of the path message, while the sink node SK is sending data packets on these paths. This also means that the beacon interval and the useful life of the path can be chosen completely independently of one another.

The marker flag MF is reset after n (where n≧1) marked data packets have been sent to the sink node SK. In particular where n>1 it is advantageous if the counter for the marked data packets still to be sent is set to n again after receipt of a beacon in which a node was queried, and/or after receipt of a data packet from the sink node SK. This course of action corresponds to method B.1.

The marker flag MF is reset by the n-th (where n≧1) beacon in which the sensor node receiving the beacon is not contained in the list of destination addresses, is therefore not queried (method B.2).

In method B.1, the existence of the downlink path SK→SO depends heavily on the traffic level between the sink node SK and the queried node SO, i.e., on the number and points in time of the data packets. It is therefore expedient to chose the useful life of the downlink path SK→SO to be sufficiently great such that in as many cases as possible the path still exists if the sink node SK should wish to send the data packet to the queried node SO. The useful life should thus be greater than the period of time between sending the marked data packet and the next data packet from the sink node SK to the queried node SO. But if the downlink path SK→SO should already have been deleted, the sink node SK must explicitly create the path again by entering the queried node SO in the list of destination addresses in the next beacon.

In method B.2, a conflict can arise with the method described above for deleting addresses from the destination address list. That is, a queried node SO removes its own address from the list of destination addresses in the beacon before it sends out the beacon. If the node receives this beacon again later, it would cease to mark its data packets. It has possibly also not yet sent any marked data packet. This situation can be taken into consideration as follows:
At least one data packet to the sink node SK after receipt of the beacon in which a subscriber node was queried is marked and the useful life of the downlink path SK→SO is chosen to be sufficiently great such that at least the sending out of the next beacon round falls within the useful life. The useful life is thus greater than the beacon interval or the useful life is greater than (n*beacon interval) if (n−1) beacon failures can be tolerated.
Queried nodes SO do not delete themselves from the list of destination addresses in the beacon on forwarding.
The list of destination addresses is only checked when the sequence number of the beacon is greater than the sequence number of the beacon through which the current path to the sink node SK was entered or, if the sequence number is the same, when the distance to the sink node SK is better.

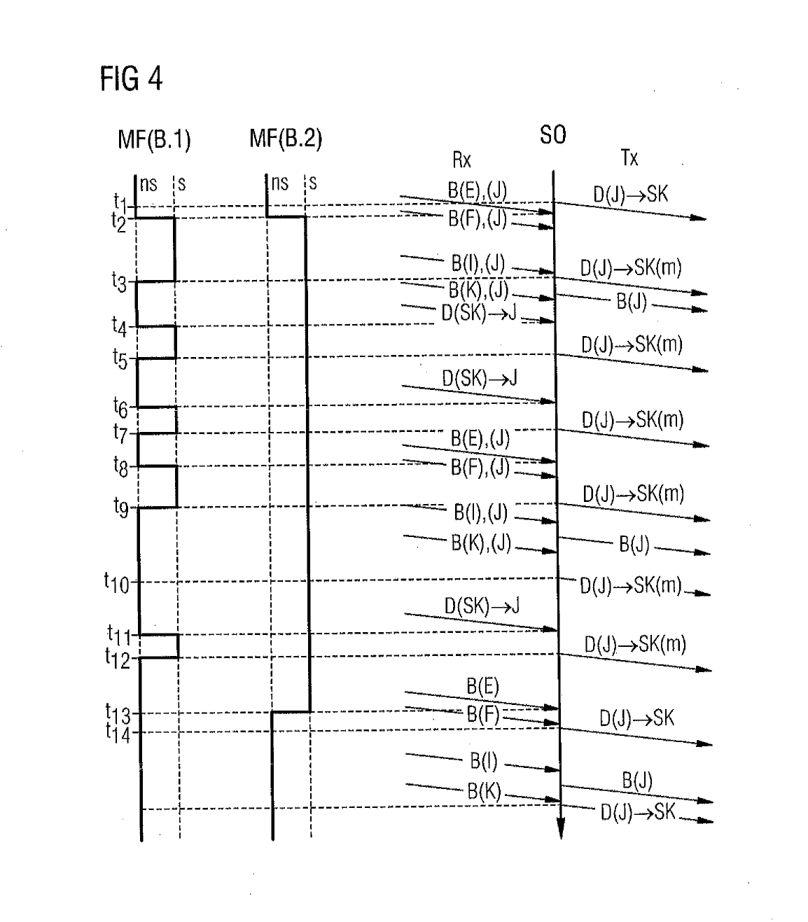

FIG. 4 shows the chronological operational sequences in the queried node SO having the address “J” (i.e., node J) corresponding to the methods B.1 and B.2, where n=1 for both variants B.1 and B.2. The useful life of the path is somewhat longer than three times the interval for sending data through the node J.

At point in time t₁, the node J sends a data packet to the sink node SK (D(J)→SK). At this point in time, in both methods B.1 and B.2, the marker flag MF(B.1) or MF(B.2) is “not set-ns”. At point in time t₂, the node J receives a beacon from the adjacent node E, in which node J is queried (B(E),(J)), whereupon the marker flag MF(B.1) or MF(B.2) changes its status to “set-s”. Between points in time t₂ and t₃, node J receives further beacons from the nodes F and I, in each of which the node J is queried, which does not however result in any change in the marker flag. Only at point in time t₃, when a marked data packet is sent out from node J to the sink node SK (D(J)→SK (m)), does the marker flag MF(B.1) in accordance with method B.1 change its status to “not set-ns”, whereas the marker flag MF(B.2) of method B.2 retains its status “set-s”. Upon receipt of a data packet from the sink node SK (D(SK)→J) at point in time t₄, the marker flag MF(B.1) in accordance with method B.1 changes its status and is again “set-s”. The sending out of a marked data packet at point in time t₅ to the sink node SK (D(J)→SK(m)) in turn changes the status of the marker flag MF(B.1), whereas the marker flag of method B.2 remains unchanged “set-s”. The described method is maintained up to point in time t₁₂. At point in time t₁₃, node J receives a beacon from node E (B(E)), in which node J is not queried, whereupon the marker flag in accordance with method B.2 MF(B.2) changes its status to “not set-ns”. A data packet from node J sent out at point in time t₁₄ to the sink node SK is accordingly no longer marked in both methods B.1 and B.2 (D(J)→SK). Since after point in time t₁₄ no further beacon is received through node J, in which beacon the node is queried, the marker flags remain unchanged at “not set-ns”.

The marked data packets of J presuppose the following entries in the routing tables of the corresponding sensor nodes. The routing table below applies in this connection to all the methods A, B.1 and B.2:

| Sensor node of | Destination | | |
|---|---|---|---|
| routing table | address | Next hop | Useful life |
| E | J | J | <useful life> |
| B | J | E | <useful life> |
| SK | J | B | <useful life> |

If the path J→SK changes when the beacons are forwarded, then the next data packet of J, marked in accordance with the invention, is placed onto this new path for the path SK→J.

With regard to the methods A, B.1 and B.2 presented, the existence of the downlink path SK→SO depends on whether data packets are sent on this path. If the path is also to be held available if no data packets are sent from the sink node to the queried node SO, then the sink node SK must insert this queried sensor node SO in the list of destination addresses in the beacon in a timely manner so that the timer for marking the data packets in the queried node SO is again set to the maximum value. Alternatively, empty data packets can also be sent.

Furthermore, general data traffic that is sent from the sensor nodes to the sink node should not generate any new path entries in the sink node. This is possible only in the case of specially marked data packets, as described above. This serves to reduce the number of path entries on the sink node SK. Only those nodes to which the sink node wishes to send are entered.

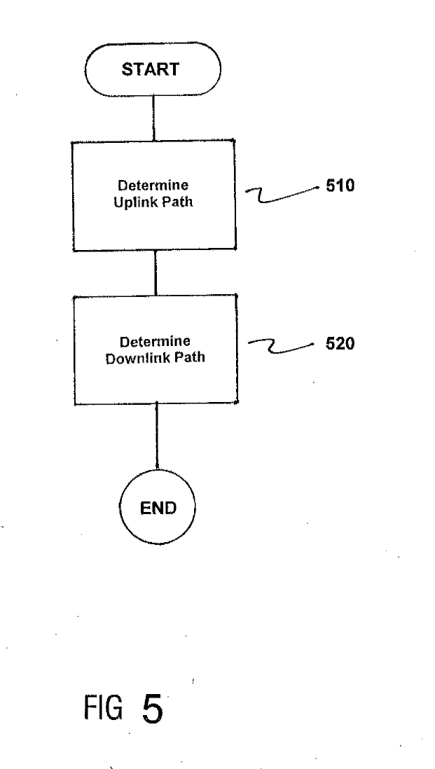

FIG. 5 is a flow chart of a method for establishing a bidirectional communication path in a wireless network including nodes comprising a sink node and a plurality of subscriber nodes, where the bidirectional communication path for bidirectional transmission of data packets is established between the sink node and at least one queried node of the plurality of subscriber nodes. The method comprises determining an uplink path from a particular subscriber node to the sink node, as indicated in step 510. Here, determining the uplink path comprises periodically exchanging path messages between adjacent nodes of the network, where a particular path message indicates a respectively shortest distance to the sink node, and administering, by each of the plurality of subscriber nodes, a path of each of the plurality of subscribers to the sink node by saving an address of an adjacent node having a best metric to the sink node for forwarding the data packets.

A downlink path is then determined from the sink node to the at least one queried node, as indicated in step 520. Here, determining the downlink path comprises inserting an address list into at least one of the path messages sent from the sink node, where the address list comprises addresses of the respectively queried nodes, inserting, by each of the plurality of subscriber nodes which receives a path message having an address list, the address list in the path message it sends out, and changing at least one subscriber node of the plurality of subscriber nodes addressed in the address list as queried nodes to a dedicated transmission state upon receiving the path message with the address list.

In alternative embodiment of the method, determining the uplink path comprises periodically exchanging path messages between adjacent nodes of the network, a particular path message indicating a respectively shortest distance to the sink node, and administering, by each of the plurality of subscriber nodes, a path of each of the plurality of subscribers to the sink node by saving the address of the adjacent node having the best metric to the sink node for forwarding the data packets. In addition, determining a downlink path comprises sending, by the sink node, in addition to the path messages sent periodically, a query message having an address list which includes an address of a particular queried node, forwarding the query message by each node receiving this query message to the respectively adjacent node, and changing the at least one subscriber node addressed in the address list as queried nodes to a dedicated transmission state upon receiving the query message with the address list.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-25. (canceled)

26. A method for establishing a bidirectional communication path in a wireless network including nodes comprising a sink node and a plurality of subscriber nodes, the bidirectional communication path for bidirectional transmission of data packets being established between the sink node and at least one queried node of the plurality of subscriber nodes, the method comprising:
determining an uplink path from a particular subscriber node to the sink node, said determining the uplink path comprising:
periodically exchanging path messages between adjacent nodes of the network, a particular path message indicating a respectively shortest distance to the sink node; and
administering, by each of said plurality of subscriber nodes, a path of each of said plural subscribers to the sink node by saving an address of an adjacent node having a best metric to the sink node for forwarding the data packets; and
determining a downlink path from the sink node to the at least one queried node, said determining the downlink path comprising:
inserting an address list into at least one of the path messages sent from the sink node, the address list comprising addresses of the respectively queried nodes;
inserting, by each of said plural subscriber node which receives a path message having an address list, the address list in the path message it sends out; and
changing at least one subscriber node of the plurality of subscriber nodes addressed in the address list as queried nodes to a dedicated transmission state upon receiving the path message with the address list.

27. The method as claimed in claim 26, wherein upon receiving the path message with the address list, the queried node removes its address from the address list before the queried node sends out its path message with the address list to the adjacent nodes.

28. The method as claimed in claim 26, wherein the subscriber node of the plurality of subscriber nodes takes account of path messages only from an adjacent node selected based on the path message as the next hop to the sink node.

29. The method as claimed in claim 27, wherein the subscriber node of the plurality of subscriber nodes takes account of path messages only from an adjacent node selected based on the path message as the next hop to the sink node.

30. The method as claimed in claim 26, wherein the wireless network comprises a wireless sensor network.

31. The method as claimed in claim 26, wherein the respectively shortest distance to the sink node is a metric.

32. A method for establishing a bidirectional communication path in a wireless network including nodes comprising a sink node and a plurality of subscriber nodes, the bidirectional communication path for the bidirectional transmission of data packets being established between the sink node and at least one queried node of the subscriber nodes, the method comprising:
determining an uplink path from a particular subscriber node of the plurality of subscriber nodes to the sink node, said determining an uplink path comprising:
periodically exchanging path messages between adjacent nodes of the network, a particular path message indicating a respectively shortest distance to the sink node; and
administering, by each of the plurality of subscriber nodes, a path of each of said plural subscribers to the sink node by saving the address of the adjacent node having the best metric to the sink node for forwarding the data packets;
determining a downlink path from the sink node to the at least one queried node, said determining the downlink path comprising:
sending, by the sink node, in addition to the path messages sent periodically, a query message having an address list which includes an address of a particular queried node;
forwarding the query message by each node receiving this query message to the respectively adjacent node; and
changing the at least one subscriber node addressed in the address list as queried nodes to a dedicated transmission state upon receiving the query message with the address list.

33. The method as claimed in claim 32, wherein subscriber nodes which are addressed in the address list remove their address from the address list prior to forwarding the query message to respectively adjacent nodes.

34. The method as claimed in claim 33, wherein the subscriber nodes which receive the query message initiated from the sink node forward the query message to adjacent nodes.

35. The method as claimed in claim 33, wherein the subscriber nodes which receive a query message initiated from the sink node with a broadcast address contained therein as the destination address of the query message do not interpret the broadcast address as a query and forward the query message to adjacent nodes.

36. The method as claimed in claim 33, wherein an indicator is inserted into the query message which signals to the nodes receiving the query message that the query message is to be forwarded to the respectively adjacent nodes even when the address list is empty.

37. The method as claimed in claim 32, wherein the at least one queried node provides at least a next data packet to be sent to the sink node in a predetermined manner with a marker which is interpreted by the plurality of subscriber nodes lying on the communication path to the sink node as an indicator for a response message.

38. The method as claimed in claim 37, wherein the plurality of subscriber nodes which lie on the path from a queried node to the sink node and the sink node, enter the downlink path in their forwarding table if the plurality of subscriber nodes which lie on the path from a queried node to the sink node and the sink node receive a marked data packet from a queried node of the plurality of queried nodes.

39. The method as claimed in claim 38, wherein at least the following items of information are entered in the forwarding table:
a destination address, which is an address of the queried node, and corresponds to a source address of a marked data packet;
an address of an adjacent subscriber node, which is an address of a next subscriber node on a path to the destination address; and
an item of information corresponding to a useful life of a communication path specifying a period of time after which the path to the queried node is deleted from the forwarding table.

40. The method as claimed in claim 39, wherein the useful life of the path from the sink node to the queried node is reset to a maximum value upon occurrence of one of a following events:
receipt or forwarding of a data packet provided with a marker from the queried node being transmitted to the sink node; and
receipt or forwarding of a data packet sent from the sink node addressed to the queried node.

41. The method as claimed in claim 39, wherein the marked data packet is provided with a sequence number.

42. The method as claimed in claim 39, wherein a need to perform path maintenance on a downlink path in a specific queried node is identified by a marker flag, wherein when the marker flag is set data packets sent to the sink node are identified by the marker.

43. The method as claimed in claim 42, wherein a timer initialized with the maximum path useful life is started when the downlink path is created.

44. The method as claimed in claim 43, wherein the marker flag and a further flag are set by a subscriber node as soon as the subscriber node becomes the queried node, wherein the further flag is deleted when the first data packet identified by a marker is transmitted to the sink node.

45. The method as claimed in claim 44, wherein the at least one queried node no longer provides a data packet to be sent to the sink node with the marker if the timer has expired and the further flag and the marker flag are not set.

46. The method as claimed in claim 44, wherein the flag is combined with a non-negative marker resource which takes account of a number of the at least marked data packets following each query by the sink node.

47. The method as claimed in claim 26, wherein a marker flag is used for an existence of the downlink path, wherein a specific queried node provides data packets sent by it to the sink node with the marker, as long as the marker flag is set.

48. The method as claimed in claim 47, wherein the marker flag is reset when a predetermined number of data packets provided with a marker have been sent to the sink node from the specific queried node.

49. The method as claimed in claim 47, wherein the marker flag is reset when the queried node is no longer contained in the address list in a predetermined number of received path messages.

50. The method as claimed in claim 42, wherein the marker flag is set by at least one of a path message in which the subscriber node is contained in the address list and data packets received by the queried node from the sink node.

51. The method as claimed in claim 32, wherein the wireless network comprises a wireless sensor network.

52. The method as claimed in claim 32, wherein the respectively shortest distance to the sink node is a metric.

53. The method as claimed in claim 36, wherein the indicator is a flag.

54. A non-transitory computer program product encoded with a computer program loadable directly into an internal memory of a digital computer and executed by the digital computer which causes establishment of a bidirectional communication path in a wireless network including nodes comprising a sink node and a plurality of subscriber nodes, the bidirectional communication path for bidirectional transmission of data packets being established between the sink node and at least one queried node of the plurality of subscriber nodes, the computer program comprising:
program code for determining an uplink path from a particular subscriber node to the sink node, said determining the uplink path comprising:
periodically exchanging path messages between adjacent nodes of the network, a particular path message indicating a respectively shortest distance to the sink node; and
administering, by each of said plurality of subscriber nodes, a path of each of said plural subscribers to the sink node by saving an address of an adjacent node having a best metric to the sink node for forwarding the data packets; and
program code for determining a downlink path from the sink node to the at least one queried node, said determining the downlink path comprising:
inserting an address list into at least one of the path messages sent from the sink node, the address list comprising addresses of the respectively queried nodes;
inserting, by each of said plural subscriber node which receives a path message having an address list, the address list in the path message it sends out; and
changing at least one subscriber node of the plurality of subscriber nodes addressed in the address list as queried nodes to a dedicated transmission state upon receiving the path message with the address list.

55. A network including nodes comprising a sink node and a plurality of subscriber nodes, a communication path for bidirectional transmission of data packets being established between the sink node and at least one queried node of the subscriber nodes, the network comprising:
an uplink path from a particular subscriber node to the sink node determinable by:
periodically exchanging path messages between adjacent nodes of the network, a particular path message indicating a respectively shortest distance to the sink node; and
administering, by each of said plurality of subscriber nodes, a path of each of said plural subscribers to the sink node by saving an address of an adjacent node having a best metric to the sink node for forwarding the data packets; and
a downlink path from the sink node to the at least one queried node determinable by:
inserting an address list into at least one of the path messages sent from the sink node, the address list comprising addresses of the respectively queried nodes;
inserting, by each of said plural subscriber node which receives a path message having an address list, the address list in the path message it sends out; and
changing at least one subscriber node of the plurality of subscriber nodes addressed in the address list as queried nodes to a dedicated transmission state upon receiving the path message with the address list.

56. The a network of claim 55, wherein the network comprises a wireless sensor network.
